(19) United States
(12) Patent Application Publication
(10) Pub. No.: US 2010/0116005 A1
(43) Pub. Date: May 13, 2010

(54) Home appliance, washing machine, and manufacturing method of home appliance

(75) Inventors: Hye Sun Jung, Gyeongsangnam-do (KR); Tae Young Jung, Gyungsangnam-do (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 12/588,952

(22) Filed: Nov. 3, 2009

Related U.S. Application Data
(60) Provisional application No. 61/112,076, filed on Nov. 6, 2008.

(30) Foreign Application Priority Data
Nov. 5, 2008 (KR) 10-2008-0109547

(51) Int. Cl. D06F 37/00; B23P 17/04

(52) U.S. Cl. 68/212; 29/428

(57) ABSTRACT

A home appliance and a washing machine are provided. The home appliance includes a casing member defining an external appearance of the home appliance, and an exterior panel coupled to an outer surface of the casing member. The exterior panel includes an ornament having a patterned portion on which an image is formed, and a transparent member integrally coupled to an outer surface of the ornament. The exterior panel provides improved material text and three-dimensional effect, arousing a user's aesthetic appreciation.

The present application claims priority to Korean Application No. 10-2008-0109547 filed in Korea on Nov. 5, 2008, and U.S. Patent Application No. 61/112,076 filed on Nov. 6, 2008 in US, the entire contents of which are hereby incorporated by reference in their entirety.

### BACKGROUND OF THE INVENTION

1. Field of the Invention

The present invention relates to a home appliance and a washing machine, and more particularly, to a home appliance and a washing machine using a patterned exterior panel for achieving improved aesthetics.

2. Discussion of the Related Art

Generally, to arouse a user's aesthetic appreciation and to achieve harmony with surrounding environments, an external appearance defining part of a home appliance, called a body, cabinet, case, casing, or the like, is subjected to painting, coating, image printing, or the like.

For example, in the case of a laundry treating machine as one kind of a washing machine, an exterior panel is attached to an outer surface of a casing member that defines an external appearance of the machine, in order to improve aesthetics of the machine according to user demand for an aesthetic product. In particular, recently, aesthetics of a home appliance is no less important, as a judgment standard of purchase, than functionality or performance and thus, improving aesthetics of a product becomes important.

Conventionally, to improve aesthetics of a product, an image has been printed on the product using a silk screen. In this case, printing an image using the silk screen is unrelated to material characteristics of a member defining a printing surface and thus, has a limit in presentation of material texture of the member and creation of three-dimensional feeling.

### SUMMARY OF THE INVENTION

An object of the present invention is to provide a home appliance, a washing machine, and a manufacturing method of the home appliance, in which an exterior panel is formed by integrally coupling an ornament, having a patterned portion on which a predetermined image is formed, and a transparent member placed on an outer surface of the ornament to each other, thereby improving material texture, aesthetics, and three-dimensional feeling of the home appliance or the washing machine.

The objects of the present invention are not limited to the above-mentioned object and other objects that have not mentioned above will become evident to those skilled in the art from the following description.

To achieve the above objects, there is provided a home appliance according to an exemplary embodiment of the present invention, including a casing member defining an external appearance of the home appliance, and an exterior panel coupled to an outer surface of the casing member, wherein the exterior panel includes an ornament having a patterned portion on which an image is formed, and a transparent member integrally coupled to an outer surface of the ornament.

To achieve the above objects, there is provided a washing machine according to another exemplary embodiment of the present invention, including a casing member having a wash tub received therein, and an exterior panel coupled to an outer surface of the casing member, wherein the exterior panel includes an ornament having a patterned portion on which an image is formed, and a transparent member integrally coupled to an outer surface of the ornament.

To achieve the above objects, there is provided a manufacturing method of a home appliance according to another exemplary embodiment of the present invention, including forming a casing member defining an external appearance of the home appliance, forming an exterior panel, and attaching the exterior panel to the casing member, wherein the formation of the exterior panel includes forming a hair line on a surface of an ornament, forming a patterned portion on the ornament, sequentially stacking Pressure Sensitive Adhesive (PSA) and a transparent member on the ornament, and compressing a stack of the transparent member, the PSA, and the ornament.

### BRIEF DESCRIPTION OF THE DRAWINGS

FIG. 1 is a front view showing a laundry treating machine according to a first embodiment of the present invention;

FIG. 2 is an enlarged perspective view of the partially cut-way portion A shown in FIG. 1, showing a door exterior panel of the laundry treating machine according to the first embodiment of the present invention;

FIG. 3 is a sectional view of the door exterior panel of the laundry treating machine according to the first embodiment of the present invention;

FIG. 4 is a sectional view showing a door of the laundry treating machine according to the first embodiment of the present invention;

FIG. 5 is a partially cut-away perspective view of the door exterior panel according to a second embodiment of the present invention;

FIG. 6 is a partially cut-away perspective view of the door exterior panel according to a third embodiment of the present invention;

FIG. 7 is a sectional view showing a control unit according to a fourth embodiment of the present invention;

FIG. 8 is a front view showing exterior panels of the laundry treating machine according to the first embodiment of the present invention;

FIG. 9 is a front view of a laundry treating machine according to a fifth embodiment of the present invention;

FIG. 10 is an exploded perspective view showing a configuration of the door exterior panel shown in FIG. 9; and

FIG. 11 is a flow chart showing a method for manufacturing the door of the laundry treating machine according to the first embodiment of the present invention.

### DETAILED DESCRIPTION OF THE PREFERRED EMBODIMENTS

The advantages and features of the present invention, and the way of attaining them, will become apparent with reference to embodiments described below in conjunction with the accompanying drawings. However, the present invention is not limited to the embodiments disclosed below and will be embodied in a variety of different forms; rather, these embodiments are provided so that this disclosure will be thorough and complete, and will fully convey the scope of the present invention to those skilled in the art, and the scope of the present invention will be defined by the appended claims. Like reference numerals refer to like elements throughout the specification.

Hereinafter, a laundry treating machine according to the embodiments of the present invention will be described with reference to the accompanying drawings.

A home appliance of the present invention refers to an electric appliance used at home, such as a laundry treating machine, refrigerator, television, or the like. In particular, a washing machine is designed to wash an object via washing, rinsing, spin-drying, drying operations, or the like. Based on the kind of an object to be washed, for example, washing machines may be classified into various kinds including a laundry treating machine and a dish washing machine. The laundry treating machine may include a washer, a dryer, a combined washing/drying machine, a spin-drier, and the like.

Although the following embodiments of the present invention describe a laundry treating machine 1 falling under the category of a washing machine, the present invention is not limited thereto and is applicable to a variety of washing machines. Furthermore, it is noted that the present invention is applicable to a variety of home appliances.

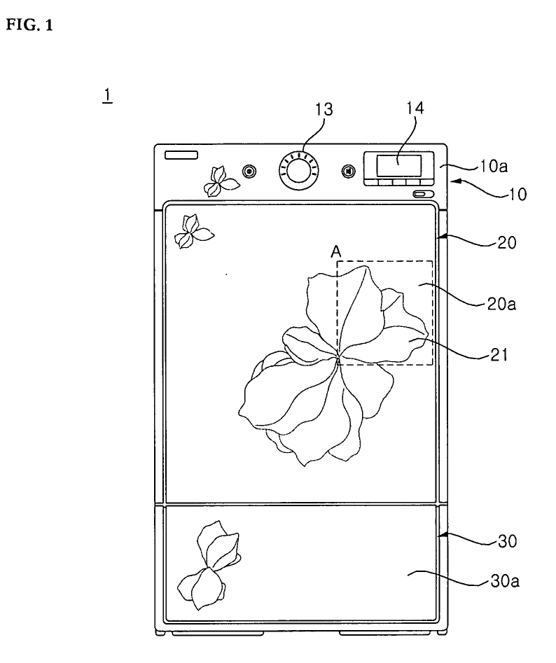

FIG. 1 is a front view showing the laundry treating machine 1 according to a first embodiment of the present invention. Referring to FIG. 1, the laundry treating machine 1 includes a body having a wash space (not shown) to wash laundry therein, a control unit 10 provided in an upper region of the body to control general operations of the laundry treating machine 1 upon receiving an operation command from a user, a door 20 to open or close a front side of the wash space, and a pedestal 30 provided in a lower region of the body to perform, e.g., drying, deodorization, and sterilization of shoes received therein.

The control unit 10 includes a display device 14 to display information related to general operations of the laundry treating machine 1. In one example, the display device 14 may be a Liquid Crystal Display (LCD) or a Light Emitting Diode (LED). The display device 14 serves to display an operation mode related to washing, rinsing, or spin-drying, a setting time or residual time of each operation mode, and the like. In addition, the control unit 10 further includes a user manipulation button 13 to allow the user to input an operation command. In one example, the user manipulation button 13 may take the form of a rotary encoder.

An external appearance defining part of a home appliance, which is called a body, case, cabinet, or the like (hereinafter, referred to as a “casing member”), is generally fabricated through injection molding. An injection molded article may allow an exterior panel to be attached to an outer surface thereof. In this case, to arouse a user's aesthetic appreciation, the exterior panel may be formed with an image, in the form of a figure, pattern, or the like, by printing or etching.

It is noted that the casing member does not essentially take the form of a single body to realize a shape of the home appliance, and may include a plurality of casing members, such as, e.g., a control unit casing member, a door casing member, and a pedestal casing member, which are coupled to each other so as to realize the overall shape of the home appliance(e.g. laundry treating machine).

The laundry treating machine 1 according to the first embodiment of the present invention includes a plurality of exterior panels. The plurality of exterior panels may include a control unit exterior panel 10a to define an external appearance of the control unit 10, a door exterior panel 20a to define an external appearance of the door 20, and a pedestal exterior panel 30a to define an external appearance of the pedestal 30.

The control unit exterior panel 10a is coupled to an outer surface of a control unit casing member defining a shape of the control unit 10. The door exterior panel 20a is coupled to an outer surface of a door casing member defining a shape of the door 20. The pedestal exterior panel 30a is coupled to an outer surface of a pedestal casing member defining a shape of the pedestal 13. The door casing member, control unit casing member, and pedestal casing member may be formed by injection molding, respectively.

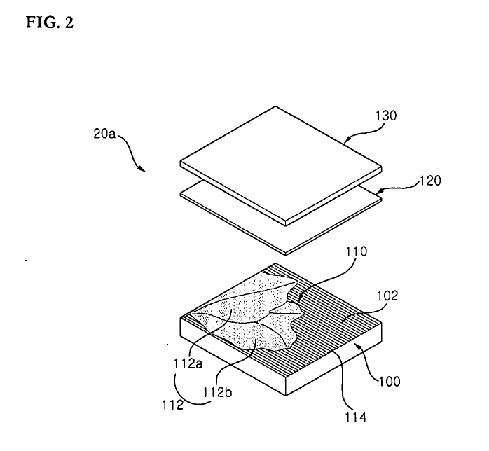

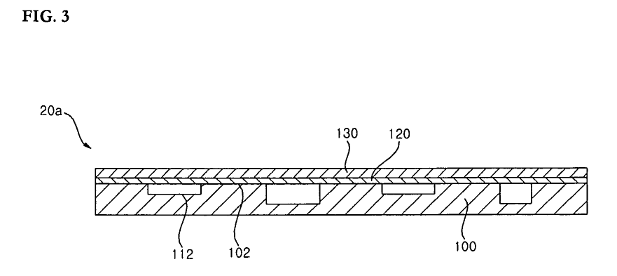

FIG. 2 is an enlarged perspective view of the partially cut-way portion A shown in FIG. 1, showing the door exterior panel 20a of the laundry treating machine 1 according to the first embodiment of the present invention. FIG. 3 is a sectional view of the door exterior panel 20a of the laundry treating machine 1 according to the first embodiment of the present invention. Referring to FIG. 2, the door exterior panel 20a includes the ornament 100 on which an image is formed by an image processing technology, such as photo-etching, and a transparent member 130 coupled to a surface of the ornament 100 by means of an adhesive member 120.

The surface of the ornament 100 is formed with an image, in the form of a figure, pattern, or the like, so as to make the ornament 100 aesthetically pleasing. Specifically, the transparent member 130 serves as a protective coating layer on the surface of the ornament 100 to allow the ornament 100 to be seen from the outside.

The ornament 100 is preferably made of a metal, which can be easily photo-etched. When the ornament 100 is made of a metal, aesthetics of the ornament 100 can be improved by maximizing material texture of the metal via polishing or photo-etching. In particular, the ornament 100 may be made of stainless steel (hereinafter, referred to as “STS”). As is known, STS has excellent corrosion-resistance, durability, and reflectivity and is easily photo-etched. In addition, when STS is subjected to cutting or photo-etching, a processed surface of STS exhibits a high gloss that is peculiar to a metal, making an external appearance of a product look more luxurious.

In more detail, the ornament 100 is formed at the surface thereof with a plurality of hair lines 102. The hair lines 102 may be formed by polishing the surface of the ornament 100 in a given direction. Specifically, the hair lines 102 may be realized by a processing device that uses an abrasive sheet formed with appropriate sizes of particles. As the abrasive sheet is rotated at a high speed, the hair lines 102 of discontinuous pitches are formed on the surface of the ornament 100.

The hair lines 102 serve to maximize the material texture of the ornament 100, and have the effects of improving material texture of a metal by polishing, preventing glare via scattered reflection of indoor light, and creating a luxurious external appearance. In particular, although a smooth metal plate may cause irregular reflection light when it is slightly deformed by external shock thus having an unpleasing external appearance, processing hair lines on a metal surface can solve this problem.

The ornament 100 is further formed at the surface thereof with a patterned portion 110. The patterned portion 110 may be realized by photo-etching. Here, photo-etching is an ultra-precision processing technology and includes coating a photo-resist film on a metal surface, exposing and developing a partial image by ultraviolet light, and then, etching the exposed metal surface.

In more detail, photo-etching is a combination of photolithography and etching. Photolithography includes applying a photo-resist solution over a substrate to form a photo-resist film, and selectively exposing and developing a partial image on the film by ultraviolet light having passed through a photo-mask (i.e. a patterned film).

Etching is a technology for selectively etching a material surface using a developed photo-resist film as a protective film. Specifically, etching is one kind of a recess forming technology for perforating and cutting a recess in a metal surface where no protective film is present via electrolytic etching or chemical etching using an acid or alkali solution, ferric chloride solution, or the like.

After completing the etching of the metal surface as described above, a finishing process for removing the protective film using an alkali solution, organic solvent, or the like may be added.

The patterned portion 110 may be formed on the surface of the ornament 100 by photo-etching. Photo-etching allows delicate lines of approximately 0.02 mm-0.03 mm to be presented on the ornament 100.

Referring to FIGS. 2 and 3, the patterned portion 110 includes recesses 112 indented from a surrounding plane by etching. The recesses 112 consist of outline recesses 112a defining an outline of an image and plane recesses 112b defining a plane of the image. In the present embodiment, the patterned portion 110 wholly defines a petal-shaped image. An outline of the image is realized by the outline recesses 112a, and a plane of the image is realized by the plane recesses 112b.

The patterned portion 110 may be realized by photo-etching in a state wherein the hair lines 102 have been formed on the ornament 100. In this case, the outline recesses 112a are preferably deeper than the plane recesses 112b and the hair lines 102.

The patterned portion 110 may include a plurality of the recesses 112. Respective ones of the plurality of recesses 112 may have various depths and widths under control of an etching degree. The various depths and widths of the plurality of recesses 112 cause, e.g., differences in paths, reflection angles, and reflected amount of light, advantageously enabling creation of a three-dimensional image. In particular, various depths of spaces are created between the transparent member 130 coupled to the surface of the ornament 100 and the plurality of recesses 112, resulting in maximized three-dimensional effect.

Meanwhile, assuming that a plastic casing member formed by injection molding is subjected to mirror printing and thereafter, a transparent member made of reinforced glass is coated on the casing member, a printed surface of the injection molded casing member may scratch the transparent member during coating. More particularly, an outline of a printed image is generally defined by a thin and sharp line raised from a surrounding plane, thus acting to scratch the transparent member.

The laundry treating machine 1 according to the first embodiment of the present invention has an advantage of preventing the transparent member 130 from being scratched because the outline recesses 112a defining the outline of the image are deeply indented from the surrounding plane.

The transparent member 130 is made of a transparent material suitable to allow the patterned portion 110 and the hair lines 102 to be seen from the outside. The transparent material may be selected from reinforced glass, glass, a PolyCarbonate (PC) sheet, and the like.

The transparent member 130 is attached to the ornament 100 by use of the adhesive member 120. The adhesive member 120 may be made of Pressure Sensitive Adhesive (PSA). In a state wherein PSA is interposed between two objects to be coupled, PSA acts to attach the two objects to each other upon receiving a predetermined pressure. PSA can achieve desired adhesive strength even under conditions of a room temperature and low pressure and therefore, has an advantage of realizing attachment of an object without deformation of the object. The adhesive member 120 is seated over the hair lines 102 of the ornament 100, serving to attach the transparent member 130 and the ornament 100 to each other.

Although photo-etching employed in the first embodiment of the present invention includes coating a photo-resist film on the ornament 100, exposing and developing a partial image on the film, and then, chemically etching the ornament 100, in an alternative embodiment, a desired shape of image may be directly sketched on the ornament 100 and thereafter, sand cutting may be performed along the sketched image. Of course, various other methods capable of etching an image in the ornament 100 may be applied without departing from the scope and sprit of the present invention.

With formation of the recesses 112, predetermined spaces are created between the transparent member 130 and the ornament 100, allowing the ornament 100 to exhibit different shadow effects and material textures according to viewing directions. That is, maximizing three-dimensional effect of the patterned portion 110 viewed from the outside is possible.

In more detail, a part of light directed to the door exterior panel 20a is reflected by a front surface of the transparent member 130, another part of the light is reflected by a front surface of the adhesive member 120 after passing through the transparent member 130, and another part of the light is reflected by the recesses 112 after passing through the adhesive member 120. In this case, maximized three-dimensional effect can be accomplished because the transparent member 130, the adhesive member 120, and the recesses 112 reflect the light at different angles. Moreover, further enhanced three-dimensional effect can be accomplished because of refraction of the light passing through the transparent member 130 and/or the adhesive member 120.

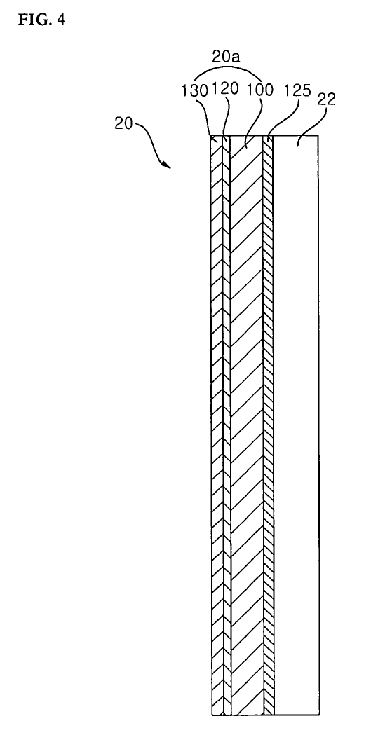

FIG. 4 is a sectional view showing the door 20 of the laundry treating machine 1 according to the first embodiment of the present invention. Referring to FIG. 4, as described above, the door exterior panel 20a is formed by integrally coupling the transparent member 130 and the ornament 100 to each other by use of the adhesive member 120. The door exterior panel 20a is coupled to the outer surface of the door casing member 22, completing formation of the door 20. In this case, the door exterior panel 20a may be attached to the door casing member 22 by use of a sealant or a double-sided tape 125. In particular, the sealant 125 is filled between the door exterior panel 20a and the door casing member 22 and can act to attach an object with excellent adhesive strength while exhibiting high water-resistance, strong cohesion for a long time, and less material deterioration and variation.

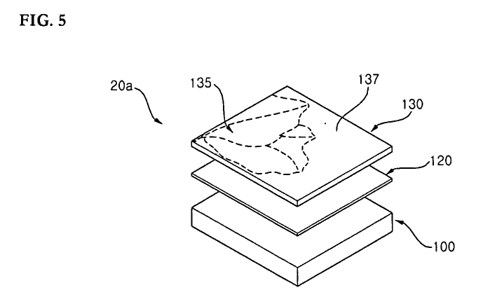

FIG. 5 is a partially cut-away perspective view of the door exterior panel 20a according to a second embodiment of the present invention. Referring to FIG. 5, the door exterior panel 20a includes the transparent member 130 formed with a patterned portion 135 on which a unique image is realized for improving aesthetics of the ornament 100. Differently from the patterned portion 130 formed at the ornament 100 of the above described first embodiment, the patterned portion 135 according to the second embodiment of the present invention is characterized by being formed at a surface of the transparent member 130. The patterned portion 135 may be realized by photo-etching. Various methods for etching glass have been known and thus, it will be appreciated that photo-etching of the transparent member 130 is also possible. Although FIG. 5 illustrates the patterned portion 135 formed at a lower surface of the transparent member 130, the patterned portion 135 may also be formed at an upper surface of the transparent member 130.

Preferably, the patterned portion 135 is recessed in the lower surface of the transparent member 130 to create a predetermined space between the transparent member 130 and the ornament 100. The ornament 100 is preferably made of a metal, such as STS. That is, the patterned portion 135 recessed in the lower surface of the transparent member 130 provides enhanced material texture of metal and three-dimensional effect.

The patterned portion 135 may be realized on the surface of the transparent member 130 by silk screen printing. The transparent member 130 may be formed with hair lines 137 by the same method as the above described first embodiment.

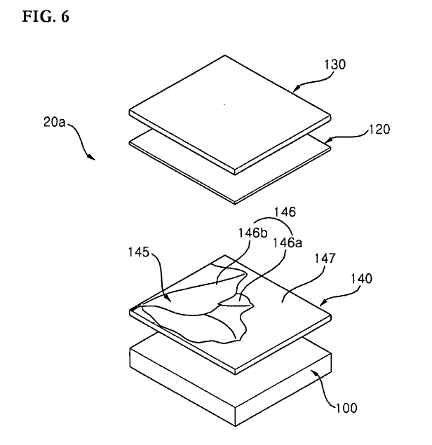

FIG. 6 is a partially cut-away perspective view of the door exterior panel 20a according to a third embodiment of the present invention. Referring to FIG. 6, the door exterior panel 20a according to the third embodiment of the present invention includes a printed layer 140 placed on the ornament 100, on which an image, in the form of a figure, pattern, or the like, is printed. The printed layer 140 is interposed between the adhesive member 120 and the ornament 100. That is, the adhesive member 120 is placed on the printed layer 140.

The printed layer 140 may be realized using a transfer-printed film or by silk screen printing. The printed layer 140 includes a patterned portion 145 formed by etching a surface of the printed layer 140. The printed layer 140 may be formed with hair lines 147, and the patterned portion 145 includes recesses 146, the hair lines 147 and the recesses 146 having the same configurations as the above described first embodiment.

The ornament 100 is preferably made of a metal, and the printed layer 140 is preferably made of a transparent material to allow metallic material texture of the ornament 100 to be seen from the outside. The printed layer 140 may be made of a transparent colored material. In this case, with cooperation of the color of the printed layer 140 and the metallic material texture of the ornament 100, enhanced aesthetics of the ornament 100 can be realized.

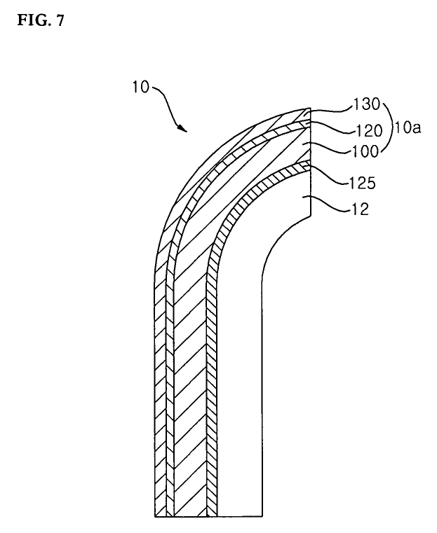

FIG. 7 is a sectional view showing the control unit according to a fourth embodiment of the present invention. The following description is given with reference to FIGS. 1 and 7.

Generally, a home appliance may have a curved surface portion. Although the exterior panel according to the present invention may be applied to a curved surface portion of the laundry treating machine 1, it will be appreciated that the use range of the exterior panel is not limited thereto and the exterior panel is applicable to curved surface portions of various home appliances. The present embodiment proposes the control unit exterior panel 10a as one example of the curved surface portion of the laundry treating machine 1. Of course, it is noted that the curved surface portion of the laundry treating machine 1 is not limited thereto.

Referring to FIG. 7, the control unit exterior panel 10a includes a curved surface portion. That is, the control unit exterior panel 10a has a shape corresponding to that of the rounded control unit casing member 12, so as to be closely attached to the control unit casing member 12.

The control unit 10 has the same configuration as that of the door 20. Specifically, the control unit 10 is configured such that the control unit exterior panel 10a is coupled to the control unit casing member 12 and in turn, the control unit exterior panel 10a is integrally formed such that the transparent member 130 and the ornament 100 are attached to each other.

Considering the fabrication of the control unit 10, first, the control unit casing member 12 is fabricated. In one example, the control unit casing member 12 may be fabricated by injection molding of plastic. The injection molding may include preparing a mold having a curved portion and injecting plastic into the mold.

The ornament 100 is preferably made of a metal, which can be easily etched. Similar to the ornament 100 of the door exterior panel 20a according to the above described first embodiment, the ornament 100 may be formed with the patterned portion by photo-etching. The ornament 100 is subjected to bending such that an inner surface of the ornament 100 is closely attached to the outer surface of the control unit casing member 12. Similarly, the transparent member 130 is subjected to bending such that an inner surface of the transparent member 130 is closely attached to an outer surface of the ornament 100. In this way, adjacent surfaces of the transparent member 130, the ornament 100, and the control unit casing member 12 are closely attached to one another.

The control unit exterior panel 10a is coupled to the control unit casing member 12 by use of the adhesive member 125, such as a sealant or a double-sided tape. The sealant has a predetermined thickness and elasticity, exhibiting excellent close-contact with respect to a curved surface portion.

Of course, in the present embodiment, the control unit exterior panel 10a may further include the printed layer in the same manner as the above described third embodiment.

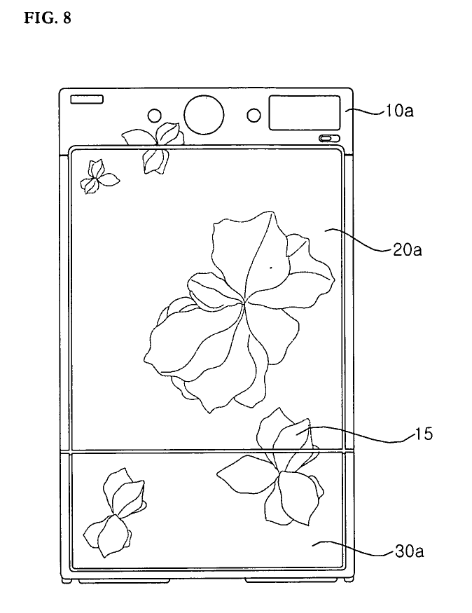

FIG. 8 is a front view showing exterior panels of the laundry treating machine 1 according to the first embodiment of the present invention. Referring to FIGS. 1 and 8, as described above, the exterior panels include the control unit exterior panel 10a, the door exterior panel 20a, and the pedestal exterior panel 30a.

In this case, the control unit exterior panel 10a, the door exterior panel 20a, and the pedestal exterior panel 30a may be formed as a single body. In one example, after a single exterior panel is patterned to form an image, the patterned exterior panel may be split into the control unit exterior panel 10a, the door exterior panel 20a, and the pedestal exterior panel 30a.

The above described exterior panel fabrication method of splitting the single patterned panel into the control unit exterior panel 10a, the door exterior panel 20a, and the pedestal exterior panel 30a has an advantage of easily realizing a continuous image throughout a plurality of adjacent panels. For example, referring to FIG. 8, a part of an image 15 belongs to the door exterior panel 20a, but the remaining part belongs to the pedestal exterior panel 30a. For this, after the image 15 is formed by photo-etching in a state wherein the door exterior panel 20a and the pedestal exterior panel 30a are formed as a single body, cutting of the single body is performed, enabling easy realization of the image 15. In particular, realizing the continuous image 15 on the neighboring panels, i.e. the door exterior panel 20a and the pedestal exterior panel 30a, may advantageously arouse unity and coordination, resulting in visual stability.

Of course, it is not essential that the control unit exterior panel 10a, the door exterior panel 20a, and the pedestal exterior panel 30a be formed as a single body. For example, an exterior panel having a curved surface portion, such as the control unit exterior panel 10a shown in FIG. 7, may be separately fabricated.

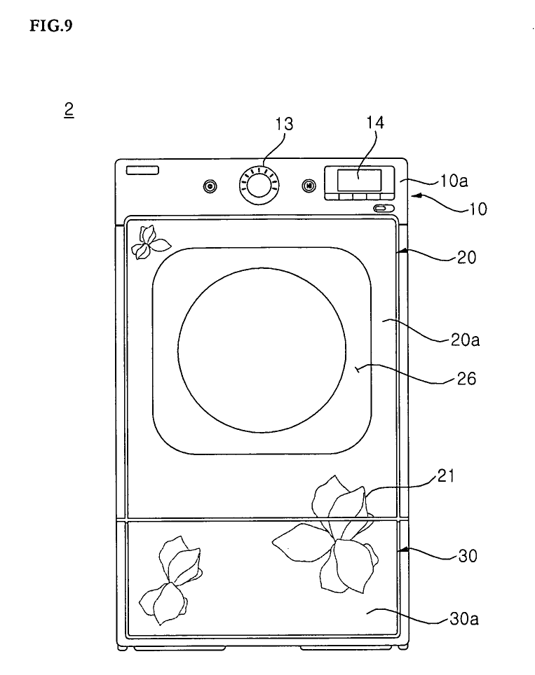

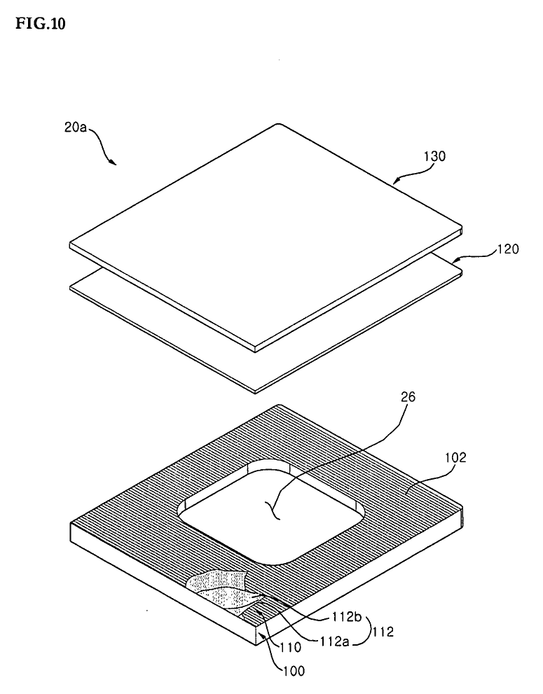

FIG. 9 is a front view of a laundry treating machine 2 according to a fifth embodiment of the present invention, and FIG. 10 is an exploded perspective view showing a configuration of the door exterior panel 20a shown in FIG. 9. In the following description with reference to FIGS. 9 and 10, the same configurations as the above described embodiments will not be described.

The laundry treating machine 2 according to the fifth embodiment of the present invention includes an observation window provided at the door 20. The user is able to observe the interior of a wash tub (not shown) through the observation window.

The door 20 includes the door casing member (not shown) having an opening perforated in an approximately central position thereof, and the door exterior panel 20a coupled to the outer surface of the door casing member. The door exterior panel 20a takes the form of a stack of the transparent member 130 and the ornament 100, and the ornament 100 includes the patterned portion 110. The ornament 100 has an observation hole 26 at a position corresponding to the opening of the door casing member.

The door casing member (not shown) attached to a rear surface of the door exterior panel 20a may have an inwardly curved surface portion. The inwardly curved surface portion has the effect of providing improved three-dimensional feeling when viewing the inwardly curved surface portion through the observation hole 26.

With relation to the patterned portion 110 formed at the ornament 100, the patterned portion 110 is formed using the same method as the above described embodiments.

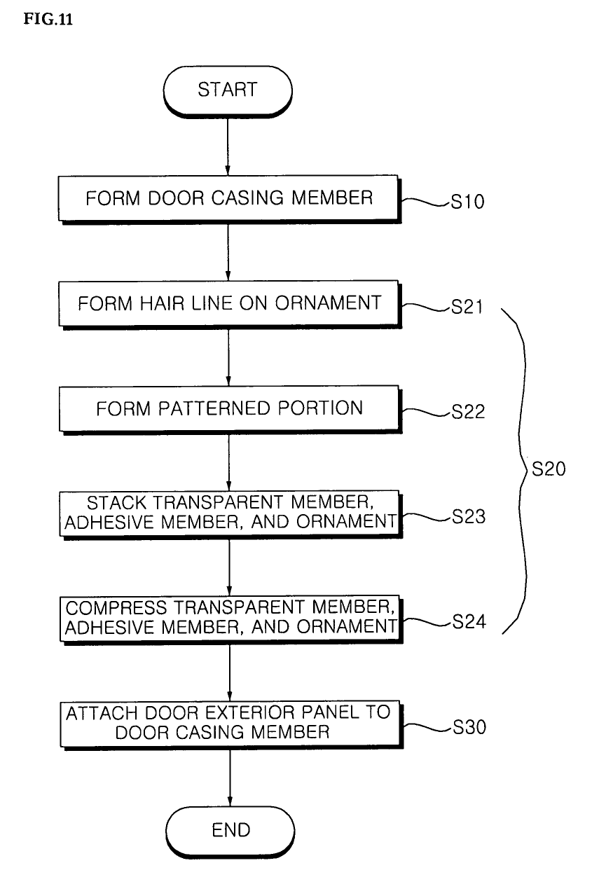

FIG. 11 is a flow chart illustrating a method for manufacturing the door 20 of the laundry treating machine according to the first embodiment of the present invention. Referring to FIGS. 1, 2, 4, and 11, the door casing member 22 is formed (S10). In one example, the door casing member 22 may be formed by injection molding of plastic.

Then, the door exterior panel 20a is formed (S20). The door exterior panel 20a includes the ornament 100 and the transparent member 130 stacked on an upper surface of the ornament 100.

Considering the operation S20 for formation of the door exterior panel 20a in more detail, first, the surface of the ornament 100, which is made of, e.g., a metal, is formed with the hair lines 102 by polishing (S21).

The patterned portion 110 is formed on the ornament 100 (S22). The patterned portion 110 may be formed by photo-etching.

The adhesive member 120 is stacked on the ornament 100 on which the hair lines 102 and the patterned portion 110 have been formed and in turn, the transparent member 130, which is made of, e.g., reinforced glass, is stacked on the adhesive member 120 (S23). In this case, the adhesive member 120 may include Pressure Sensitive Adhesive (PSA).

The stack of the transparent member 130, the adhesive member 120, and the ornament 100 is compressed (S24). In this case, the transparent member 130 and the ornament 100 are attached to each other when pressure is applied to the PSA constituting the adhesive member 120.

The door exterior panel 20a, formed in operation S20, is attached to the outer surface of the door casing member formed in operation S10, by use of a sealant or a double-sided tape.

With the above described manufacturing method, the door 20 can be simply manufactured by attaching the integrally formed door exterior panel 20a to the outer surface of the door casing member 22.

Of course, the present invention is not limited to the manufacturing method of the door exterior panel 20a, and may be applied to all kinds of home appliances. In particular, it is noted that the present invention is applicable to various laundry treating machines.

When forming an exterior panel of a home appliance having a curved surface portion, preferably, after an image is realized on a flat exterior panel, the exterior panel is subjected to bending to correspond to the casing member having a curved surface portion and thereafter, is attached to the casing member.

It will be understood by those skilled in the art that example embodiments can be implemented in other specific forms without changing the technical spirit or essential features of the present invention. Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

According to a home appliance and a washing machine of the present invention, one or more effects as follows may be achieved.

First, as a result of providing an ornament with a patterned portion on which an image is formed and closely attaching a transparent member to a surface of the ornament, enhanced material texture and three-dimensional effect can be accomplished, arousing a user's aesthetic appreciation.

Second, with the manufacturing method of the home appliance according to the present invention, the integrally formed patterned exterior panel is attached to the casing member, resulting in simplified formation of the exterior panel of the home appliance.

The effects of the present invention are not limited to the above-mentioned effects, and other effects not mentioned above can be clearly understood from the definitions in the claims by one skilled in the art.

What is claimed is:

1. A home appliance comprising:
a casing member defining an external appearance of the home appliance; and
an exterior panel coupled to an outer surface of the casing member,
wherein the exterior panel includes:
an ornament having a patterned portion on which an image is formed; and
a transparent member integrally coupled to an outer surface of the ornament.

2. The home appliance of claim 1, wherein:
the casing member includes a curved surface portion; and
the exterior panel is subjected to bending, so as to correspond to the curved surface portion.

3. The home appliance of claim 1, wherein the patterned portion is formed by photo-etching a surface of the ornament.

4. The home appliance of claim 3, wherein the photo-etching includes:
a photolithography process to form a pattern; and
an etching process to etch the ornament based on the pattern.

5. The home appliance of claim 3, wherein the patterned portion includes at least one recess formed by the photo-etching.

6. The home appliance of claim 5, wherein:
the at least one recess includes a plurality of recesses; and
the plurality of recesses includes two or more recesses having different depths.

7. The home appliance of claim 1, wherein the patterned portion includes an outline recess indented from a surrounding plane to define an outline of the image.

8. The home appliance of claim 1, wherein the ornament is made of stainless steel.

9. The home appliance of claim 1, wherein the transparent member and the ornament are coupled to each other by Pressure Sensitive Adhesive (PSA).

10. The home appliance of claim 1, wherein the casing member and the ornament are coupled to each other by use of a sealant or a double-sided tape.

11. The home appliance of claim 1, wherein the ornament includes a hair line formed by polishing.

12. The home appliance of claim 1, wherein:
the exterior panel includes a window; and
the window includes an observation hole perforated in the ornament.

13. The home appliance of claim 1, wherein:
the at least one casing member includes a plurality of casing members; and
the exterior panel is formed as a single body, so as to be mounted to the plurality of casing members.

14. A washing machine comprising:
a casing member having a wash tub received therein; and
an exterior panel coupled to an outer surface of the casing member,
wherein the exterior panel includes:
an ornament having a patterned portion on which an image is formed; and
a transparent member integrally coupled to an outer surface of the ornament.

15. The washing machine of claim 14, wherein:
the casing member includes a curved surface portion; and
the exterior panel is subjected to bending, so as to correspond to the curved surface portion.

16. The washing machine of claim 14, wherein the patterned portion is formed by photo-etching a surface of the ornament.

17. The washing machine of claim 16, wherein the photo-etching includes:
a photolithography process to form a pattern; and
an etching process to etch the ornament based on the pattern.

18. The washing machine of claim 16, wherein the patterned portion includes at least one recess formed by the photo-etching.

19. The washing machine of claim 18, wherein:
the at least one recess includes a plurality of recesses; and
the plurality of recesses includes two or more recesses having different depths.

20. The washing machine of claim 14, wherein the patterned portion includes an outline recess indented from a surrounding plane to define an outline of the image.

21. The washing machine of claim 14, wherein the ornament is made of stainless steel.

22. The washing machine of claim 14, wherein the transparent member and the ornament are coupled to each other by Pressure Sensitive Adhesive (PSA).

23. The washing machine of claim 14, wherein the casing member and the ornament are coupled to each other by use of a sealant or a double-sided tape.

24. The washing machine of claim 14, wherein the ornament includes a hair line formed by polishing.

25. The washing machine of claim 14, wherein:
the casing member is a door casing member to open or close the wash tub;
the exterior panel is a door exterior panel coupled to an outer surface of the door casing member;
the door exterior panel includes a window; and
the window includes an observation hole perforated in the ornament.

26. The washing machine of claim 14, wherein:
the at least one casing member includes a plurality of casing members; and
the exterior panel is formed as a single body, so as to be mounted to the plurality of casing members.

27. A manufacturing method of a home appliance comprising:
forming a casing member defining an external appearance of the home appliance;
forming an exterior panel; and
attaching the exterior panel to the casing member,
wherein the formation of the exterior panel includes:
forming a hair line on a surface of an ornament;
forming a patterned portion on the ornament;
sequentially stacking Pressure Sensitive Adhesive (PSA) and a transparent member on the ornament; and
compressing a stack of the transparent member, the PSA, and the ornament.

28. The manufacturing method of claim 27, wherein the formation of the hair line is performed by polishing the surface of the ornament.

29. The manufacturing method of claim 27, wherein the formation of the patterned portion is performed by photo-etching.

30. The manufacturing method of claim 27, wherein the attachment of the casing member and the exterior panel includes attaching the casing member and the exterior panel to each other by use of a sealant or a double-sided tape.
